(19) United States
(12) Patent Application Publication
(10) Pub. No.: US 2007/0002366 A1
(43) Pub. Date: Jan. 4, 2007

(54) Image editing system for editing images within a server

(75) Inventor: Shun-Ping Wang, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/171,411

(22) Filed: Jul. 1, 2005

(51) Int. Cl. G06F 3/12

(52) U.S. Cl. 358/1.15; 358/452

(57) ABSTRACT

An image editing system includes an image capturing device for capturing images in electronic image files; an edition mode-selecting module capable of selecting one edition mode signal; a communication module for transmitting the selected electronic image file and the selected edition mode signal to a distal server; an image editing module disposed within the distal server for conducting an editing operation onto the selected electronic image file upon coincidence occurs between the selected edition mode signal and a corresponding edition mode, thereby converting the selected electronic image file into an edited image file; and a transmitting module for transmitting the edited image file to a mobile phone so that the edited image file is displayed over the mobile phone.

### FIELD OF THE INVENTION

The invention relates to an image editing system, more particularly to an image editing system for editing images within a distal server. The images are captured by a mobile phone, and are latter transmitted to the distal server in an electronic image file for edition.

### BACKGROUND OF THE INVENTION

A mobile phone is very common in our daily to facilitate a busy person of nowadays to accomplish some of his daily works, like noting down the business appointments, tracking the lists of stocks, making simple calculation, storing addresses of the clients, and transmitting e-mails.

Referring to FIG. 1, a conventional mobile phone 2 of lately is shown to include an image capturing device 4, a communication module 6, a memory device 12, and a display 10. The image-capturing device 4 can capture image digitally (i.e. converting light into electric charge and process it into electronic images). The images are later stored as electronic image files within the memory device 12. The communication module 6 is capable of transmitting and downloading messages and electronic image files, in addition to making and receiving calls. As a general rule, the images captured by the image-capturing device 4 or downloaded by the communication module 6 cannot be edited within the conventional mobile phone 2. However, some of the conventional mobile phones (such as the one shown in FIG. 1) can edit the images therewithin, since the former is provided with an image-editing module 8.

One drawback of the aforesaid conventional mobile phone resides in that a typical image editing software package requires a relatively large amount of storage space. Since the computing ability thereof is limited due to its small storage space in the memory device 12. The conventional mobile phone can only do some simple editing operation (such as correcting the color and changing the size of the image). Therefore, if the user wishes to have a studio-quality or high-quality photo (like a masterpiece photo with artistic values), he must resolve the other method.

### SUMMARY OF THE INVENTION

The object of the present invention is to provide an image editing system that can edit images within a distal server such that the edited image file can have a high-quality photo effects when printed out. The images are first captured by a mobile phone and are later transmitted to the server, where they are edited.

An image editing system is provided according to the present invention for editing images within a distal server. The images are captured by a mobile phone and are later transmitted to the distal server. The image editing system accordingly includes: an image capturing device for disposing within the mobile phone in order to capture the images in electronic image files; an edition mode-selecting module for disposing within the mobile phone and capable of selecting one edition mode signal from a plurality of edition mode signals which are stored within the edition mode-selecting module in advance; a communication module for disposing within the mobile phone and capable of transmitting a selected one of the electronic image files and the selected edition mode signal to the distal server; an image editing module for disposing within the distal server, wherein a plurality of edition modes are stored within the image editing module, the image editing module conducting an editing operation onto the selected one of the electronic image files upon coincidence occurs between the selected edition mode signal and a corresponding one of the edition modes, thereby converting the selected one of the electronic image files into an edited image file; a transmitting module for disposing within the distal server and for transmitting the edited image file to the mobile phone; and a display provided in the mobile phone for displaying the edited image file.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a conventional mobile phone;

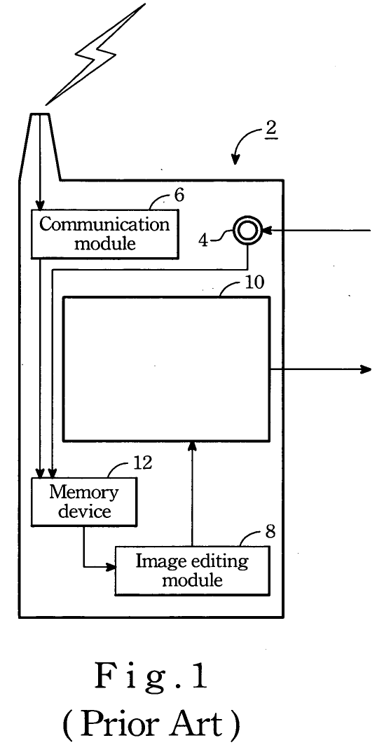

FIG. 2 is an image editing system according to the present invention shown together with a distal server and a mobile phone, illustrating interrelationship thereamong;

FIG. 3 is a block diagram, illustrating the image editing system of the present invention; and

FIG. 4 illustrates how an edited image file is displayed over a display device of the image editing system of the present invention.

### DETAILED DESCRIPTIONS OF THE PREFERRED EMBODIMENT

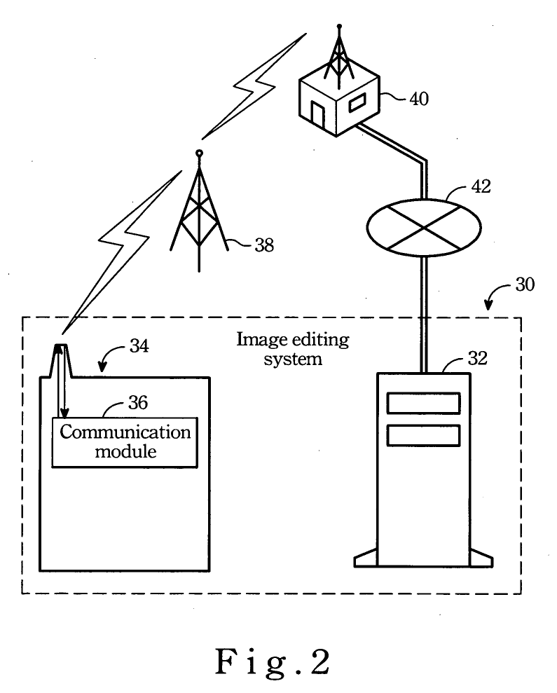

Referring to FIG. 2, an image editing system 30 according to the present invention is shown together a distal server 32 and a mobile phone 34. The distal server 32 is communicated with a base station 40 via a network 42 (such as the Internet) while the mobile phone 34 is communicated with the base station 40 via a cell tower 38.

The image editing system 30 is capable of editing images within the distal server 32. The images are firstly captured by the mobile phone 34 and are later transmitted to the distal server 32 for edition.

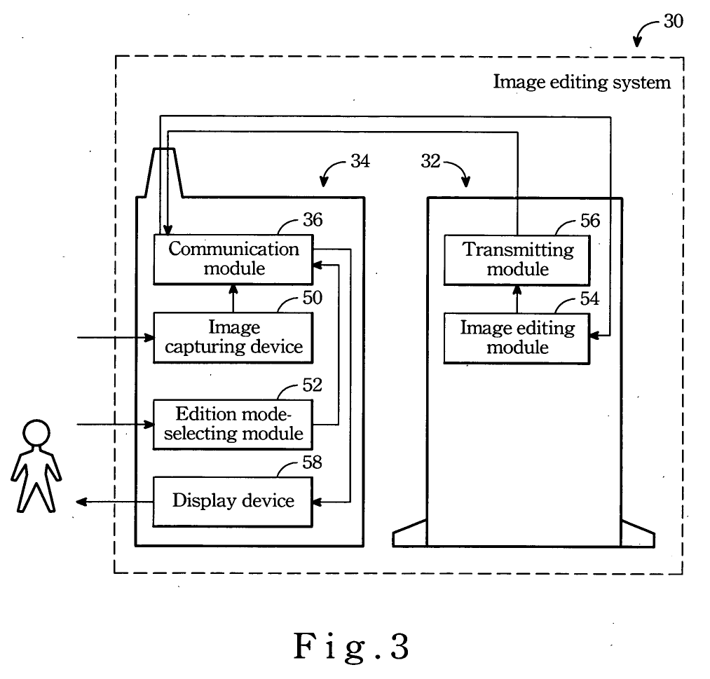

As best illustrated in FIG. 3, the image editing system 30 of the present invention includes an image capturing device 50, an edition mode-selecting module 52, a communication module 36, an image editing module 54, a transmitting module 56, and a display device 58. The image-capturing device 50 is disposed within the mobile phone 34 in order to capture the images, thereby converting the images into electronic image files. The edition mode-selecting module 52 is disposed within the mobile phone 34, and is capable of selecting one edition mode signal from a plurality of edition mode signals, which are stored within the edition mode-selecting module 52 in advance. The communication module 36 is disposed within the mobile phone 34, and is capable of transmitting a selected one of the electronic image files and the selected edition mode signal to the distal server 32. The image-editing module 54 is disposed within the distal server 32, wherein pluralities of edition modes are stored within the image-editing module 54. The image editing module 54 conducts an editing operation onto the selected one of the electronic image files upon coincidence occurs between the selected edition mode signal and a corresponding one of the edition modes, thereby converting the selected one of the electronic image files into an edited image file. The transmitting module 56 is disposed within the distal server 32 for transmitting the edited image file to the mobile phone 34. The display device 58 is provided in the mobile phone 34 for displaying the edited image file.

In the image editing system 30 of the present invention, the communication module 36 of the mobile phone 34 transmits the selected electronic image file and the selected edition mode signal to the distal server 32 via the base station 40 in order to permit the distal server 32 to conduct the editing operation.

The image capturing device 50 employed in the image editing system 30 of the present invention can be any image sensor, such as CMOS (Complementary Metal Oxide Semiconductor) and CCD (Charge Coupled Device).

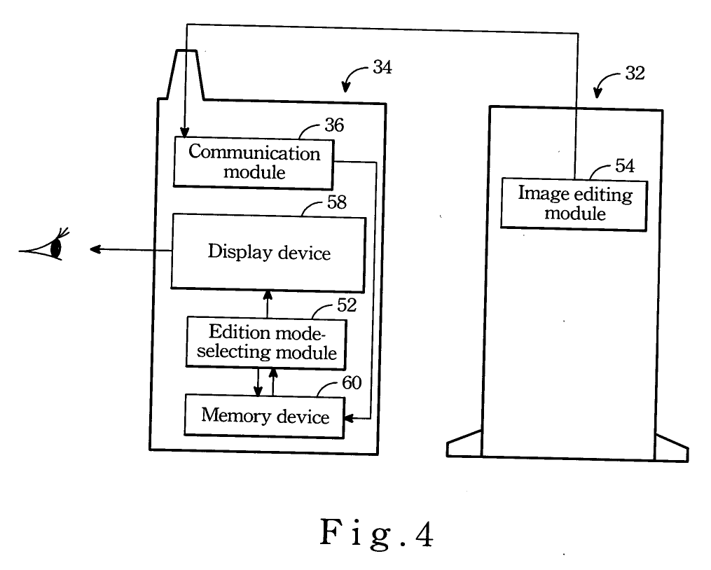

Since the display device 58 is provided in the mobile phone 34, the selected electronic image file and the selected edition mode signal are shown thereon prior to being transmitted to the distal server. In the same manner, the mobile phone 34 is capable of downloading the edited image file via the communication module 36 such that the edited image file can be stored within a memory device 60 employed in the mobile phone 34. The edited image file can be displayed over the display device 58 prior to being printed out in the photo format (see FIG. 4).

As it known in the art, the distal server 32 has high efficient computing ability and is provided with a plurality of complicated and sophisticated software packages in order to conduct several specific tasks. The image editing operation may include correcting the ambient brightness of an image in order to view the image more vividly, adding a background to the image so as to render the photo more amusing and interesting, or enlarging a specific part of the photo relative to the remaining parts thereof in order to emphasize the importance of the specific part. Such type of image editing operation can be carried out only in the distal server 32.

Since the images taken by the mobile phone 34 and the printout photos from the edited image file have the studio-quality standard, the drawback as encountered during use of the conventional mobile phone is accordingly eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An image editing system for editing images within a distal server, the images being captured by a mobile phone and later transmitted to the distal server, the image editing system comprising:
an image-capturing device for disposing within the mobile phone in order to capture the images in electronic image files;
an edition mode-selecting module for disposing within the mobile phone, and capable of selecting one edition mode signal from a plurality of edition mode signals, which are stored within said edition mode-selecting module in advance;
a communication module for disposing within the mobile phone, and capable of transmitting a selected one of said electronic image files and said selected edition mode signal to the distal server;
an image editing module for disposing within the distal server, wherein a plurality of edition modes are stored within said image editing module, said image editing module conducting an editing operation onto said selected one of said electronic image files upon coincidence occurs between said selected edition mode signal and a corresponding one of said edition modes, thereby converting said selected one of said electronic image files into an edited image file;
a transmitting module for disposing within the distal server and for transmitting said edited image file to the mobile phone; and
a display device provided in the mobile phone for displaying said edited image file.

2. The image editing system according to claim 1, wherein the mobile phone is communicated with a base station via a cell tower, said communication module transmitting said selected one of said electronic image files and said selected edition mode signal to the distal server via said base station in order to permit the distal server to conduct said editing operation.

3. The image editing system according to claim 1, wherein the distal server is communicated with said base station via a network.

4. The image editing system according to claim 1, wherein said image capturing device is CMOS (Complementary Metal Oxide Semiconductor).

5. The image editing system according to claim 1, wherein said image capturing device is CCD (Charge Coupled Device).

6. The image editing system according to claim 1, wherein said selected one of said electronic image files and said selected edition mode signal are shown in said display device of the mobile phone prior to being transmitted to the distal server.

7. The image editing system according to claim 1, wherein the mobile phone is capable of downloading said edited image file via said communication module.
